(19) United States
(12) Patent Application Publication
(10) Pub. No.: US 2019/0058529 A1
(43) Pub. Date: Feb. 21, 2019

(54) TURBO RECEIVERS FOR SINGLE-INPUT SINGLE-OUTPUT UNDERWATER ACOUSTIC COMMUNICATIONS

(71) Applicants: YAHONG ROSA ZHENG, Rolla, MO (US); WEIMIN DUAN, San Diego, CA (US); CHENGSHAN XIAO, Rolla, MO (US)

(72) Inventors: YAHONG ROSA ZHENG, Rolla, MO (US); WEIMIN DUAN, San Diego, CA (US); CHENGSHAN XIAO, Rolla, MO (US)

(21) Appl. No.: 15/945,198

(22) Filed: Apr. 4, 2018

Related U.S. Application Data
(60) Provisional application No. 62/483,358, filed on Apr. 8, 2017.

(51) Int. Cl. H04B 13/02; H04L 1/00; H04L 25/03; H04B 11/00

(52) U.S. Cl. CPC H04B 13/02; H04L 1/0055; H04L 25/03171; H04L 25/03057; H04L 2025/03426; H04L 2025/0342; H04L 2025/03401; H04L 2025/03636; H04B 11/00

(57) ABSTRACT

Systems and methods for underwater communication using a SISO acoustic channel. An acoustic receiver may receive a signal comprising information encoded in at least one transmitted symbol. Using a Bi-SDFE, the at least one transmitted symbol is estimated. The Bi-SDFE may include a SDFE and a time-reversed SDFE that each output bit extrinsic LLRs, which are combined into combined bit extrinsic LLRs. The estimated symbol is then mapped to the combined bit extrinsic LLRs, the result of which is de-interleaved. Iterative bit extrinsic LLRs are generated with a MAP and/or soft-decision decoder using the mapped, combined bit extrinsic LLRs as a priori LLRs for the Bi-SDFE in another iterative estimation. The iterative bit extrinsic LLRs are interleaved and transmitted for use by the Bi-SDFE in another iterative estimation. After a plurality of iterations, a hard decision of the transmitted symbol is generated with the MAP and/or soft-decision decoder.

### CROSS-REFERENCE TO RELATED APPLICATIONS

This application, having attorney docket number 17MST015/UNOM.271561 and entitled “Improved Turbo Receivers for Single-Input Single-Output Underwater Acoustic Communications,” claims priority to U.S. Provisional Application 62/483,358, filed Apr. 8, 2017, entitled “Improved Turbo Receivers for Single-Input Single-Output Underwater Acoustic Communications.” The entirety of the aforementioned application is incorporated by reference herein.

### STATEMENT REGARDING FEDERALLY SPONSORED RESEARCH OR DEVELOPMENT

This invention was made with U.S. Government support by way of Grant Numbers ECCS-0846486 and ECCS-1408316 awarded by the National Science Foundation and Grant Number N00014-10-1-0174 awarded by the Office of Naval Research. The Government has certain rights in the invention. See 35 U.S.C. § 202(c)(6).

### FIELD

The present invention relates generally to improved systems and methods for performing equalization and decoding of single-input single-output (“SISO”) underwater acoustic communications.

### BACKGROUND

Wireless underwater communication using an acoustic channel as the physical layer for communication is desirable for many types of scientific and commercial endeavors in the ocean. However, the underwater acoustic (“UWA”) channel presents many unique challenges for the design of underwater communication systems. Some of these challenges include time-varying multipath signals due to reflections off the moving surface waves and rough ocean bottom, which can cause echoes and signal interference. Further, relative motion of a transmitter and a receiver induces Doppler spread of the signal. In addition, noise is introduced by wind, shipping traffic, and various forms of ocean life, which can mask a portion of the signal and block the corresponding carried data. These challenges can cause the UWA signal to fluctuate randomly and as a result make the selection of modulation and error correction techniques very challenging.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

At a high level, aspects of this disclosure provide technologies for underwater communication systems and, in some embodiments in particular, systems and methods that utilize turbo equalization of SISO UWA transmissions. The turbo equalization may be performed by a receiver using a bidirectional soft-decision feedback turbo equalizer (“Bi-SDFE”) or various other channel estimation minimum mean squared error turbo equalizers (“CE MMSE-TEQs”) and direct-adaptation turbo equalizers (“DA-TEQs”). In some embodiments, the Bi-SDFE may use a time-reversed soft-decision feedback equalizer (“SDFE”) in conjunction with a normal SDFE to harvest the time-reverse diversity in decision feedback equalization. Both the normal SDFE and the time-reversed SDFE may be low-complexity SDFEs. A linear combining scheme may be used to combine extrinsic log likelihood ratios (“LLRs”) at the outputs of each of the normal SDFE and the time-reversed SDFE thus achieving better robustness and performance of the receiver. The combined LLRs are used to estimate coefficients of a covariance matrix and a mean vector of the outputs of the normal SDFE and the time-reversed SDFE by time averaging. The estimated covariance matrix and the mean vector of the outputs are then used for adaptation of the SDFE filter coefficients in a next iteration of turbo equalization. In this way, embodiments of this disclosure improve UWA communication systems by increasing reliability; reducing complexity, size, and cost; and making such systems more robust under harsh channel conditions as well as the expected challenges present in an underwater environment.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention is described in detail herein with reference to the attached drawing figures, which are incorporated herein by reference, wherein:

FIG. 1 depicts an exemplary operating environment for a SISO UWA communication system in accordance with an aspect hereof;

FIG. 2 depicts a block diagram of an exemplary transmitter of the SISO UWA communication system in accordance with an aspect hereof;

FIG. 3 depicts a block diagram of an exemplary turbo receiver of the SISO UWA communication system in accordance with an aspect hereof;

FIG. 4 depicts a block diagram of an exemplary channel-estimation based bidirectional soft-decision feedback turbo equalizer in accordance with an aspect hereof;

FIG. 5 depicts an exemplary channel-estimation based soft-decision feedback turbo equalizer in accordance with an aspect hereof;

FIG. 6 depicts an exemplary channel-estimation based linear minimum mean squared error turbo equalizer in accordance with an aspect hereof;

FIG. 7 depicts an exemplary soft decision direct-adaptation turbo equalizer in accordance with an aspect hereof;

FIG. 8 depicts a flow diagram illustrating a method for underwater communication using a SISO channel in accordance with an aspect hereof;

FIG. 9 depicts a flow diagram illustrating a method of estimating a transmitted symbol using a bidirectional soft-decision feedback turbo equalizer in accordance with an aspect hereof;

FIG. 10 depicts the burst scheme of the nth transmit branch in the SPACE08 experiment used for a test of aspects hereof;

FIG. 11 depicts the time evolution of four typical channel impulse responses obtained in the test of aspects hereof;

FIG. 12 depicts a plot of bit-error-rate versus packet index using QPSK modulation during the test of channel estimation based turbo equalizers in accordance with aspects hereof;

FIG. 13 depicts a plot of bit-error-rate versus packet index using 8PSK modulation during the test of channel estimation based turbo equalizers in accordance with aspects hereof;

FIG. 14 depicts a plot of bit-error-rate versus packet index using 16QAM modulation during the test of channel estimation based turbo equalizers in accordance with aspects hereof;

FIG. 15 depicts a plot of bit-error-rate versus packet index using QPSK modulation during the test of soft decision direct-adaptation turbo equalizers in accordance with aspects hereof;

FIG. 16 depicts a plot of bit-error-rate versus packet index using 8PSK modulation during the test of soft decision direct-adaptation turbo equalizers in accordance with aspects hereof;

FIG. 17 depicts a plot of bit-error-rate versus packet index using 16QAM modulation during the test of soft decision direct-adaptation turbo equalizers in accordance with aspects hereof; and

FIG. 18 is a block diagram illustrating an exemplary computing device that may be used with systems and methods in accordance with aspects hereof.

### DETAILED DESCRIPTION

Subject matter is described throughout this disclosure in detail and with specificity in order to meet statutory requirements. But the aspects described throughout this disclosure are intended to be illustrative rather than restrictive, and the description itself is not intended necessarily to limit the scope of the claims. Rather, the claimed subject matter might be practiced in other ways to include different elements or combinations of elements that are similar to the ones described in this disclosure and that are in conjunction with other present, or future, technologies. Upon reading the present disclosure, alternative aspects may become apparent to ordinary skilled artisans that practice in areas relevant to the described aspects, without departing from the scope of this disclosure. It will be understood that certain features and subcombinations are of utility and may be employed without reference to other features and subcombinations. This is contemplated by and is within the scope of the claims.

As described above, the underwater acoustic (“UWA”) channel presents many unique problems for the design of underwater communication systems. These problems, which can cause the UWA signal to fluctuate randomly, include inter alia, attenuation due to the absorption of the acoustic waves in water, low propagation speed of the sound, multipath due to the reflection from the bottom and surface of the sea causing echoes and interference, heterogeneous characteristics of the UWA channel as well as Doppler's effect caused by the movement of the water medium, the transmitter and/or the receiver, and noise in the ocean that can mask a portion of the signal and block the corresponding carried data.

Regarding the multipath problem, the effect of time-varying multipath propagation is intersymbol interference (“ISI”) in the digital communication system that extends over several tens to several hundreds of symbol periods. To mitigate some of these challenges, high-data-rate coherent modulation and detection in UWA communications are utilized. Effective synchronization is inhibited by time-varying ISI and effective equalization of such ISI relies on successful synchronization. Thus, a receiver is utilized that jointly addresses synchronization and equalization. The receiver employs an adaptive decision feedback equalizer (“DFE”) with embedded carrier recovery. The equalizer coefficients and carrier recovery parameters then can be jointly estimated according to a minimum mean square error (“MMSE”) criterion.

Turbo equalization provides significant performance gains, even in severe ISI channels, through iterative soft-input/soft-output equalization and decoding. Currently, two classes of turbo equalizers may be used in UWA communications: channel estimation based minimum mean square error turbo equalizer (“CE MMSE-TEQ”) and direct-adaptation turbo equalizer (“DA-TEQ”).

When using a CE MMSE-TEQ, the UWA channel may be explicitly estimated and incorporated into the calculation of MMSE equalizer coefficients. When using a DA-TEQ, the coefficients of the equalizer may be directly estimated with adaptive algorithms. Since a large size matrix inversion operation in the CE MMSE-TEQ is avoided, the DA-TEQ exhibits lower complexity and is more attractive for hardware implementation. After initial training, DA-TEQs typically use hard-decisions of the equalizer output to track the time-variations of the UWA channel. A drawback of this hard decision directed adaptation is the error propagation, which may result into a catastrophic failure of the convergence.

Additionally, conventional implementations of turbo equalization in UWA communication systems require a physical hydrophone array at the receiver. However, a practical issue for undersea network or point-to-point UWA communications is the physical size of the modems. In contrast, embodiments of the present disclosure provide a robust solution to the UWA channel problems using a single receiving element.

At a high level, aspects of this disclosure provide technologies for underwater communication systems and, in some embodiments in particular, systems and methods that utilize turbo equalization of SISO UWA transmissions. The turbo equalization may be performed by a receiver using a bidirectional soft-decision feedback turbo equalizer (“Bi-SDFE”) or various other channel estimation minimum mean squared error turbo equalizers (“CE MMSE-TEQs”) and direct-adaptation turbo equalizers (“DA-TEQs”). In some embodiments, the Bi-SDFE may use a time-reversed soft-decision feedback equalizer (“SDFE”) in conjunction with a normal SDFE to harvest the time-reverse diversity in decision feedback equalization. Both the normal SDFE and the time-reversed SDFE may be low-complexity SDFEs. A linear combining scheme may be used to combine extrinsic log likelihood ratios (“LLRs”) at the outputs of each of the normal SDFE and the time-reversed SDFE thus achieving better robustness and performance of the receiver. The combined LLRs are used to estimate coefficients of a covariance matrix and a mean vector of the outputs of the normal SDFE and the time-reversed SDFE by time averaging. The estimated covariance matrix and the mean vector of the outputs are then used for adaptation of the SDFE filter coefficients in a next iteration of turbo equalization. In this way, embodiments of this disclosure improve UWA communication systems by increasing reliability; reducing complexity, size, and cost; and making such systems more robust under harsh channel conditions as well as the expected challenges present in an underwater environment.

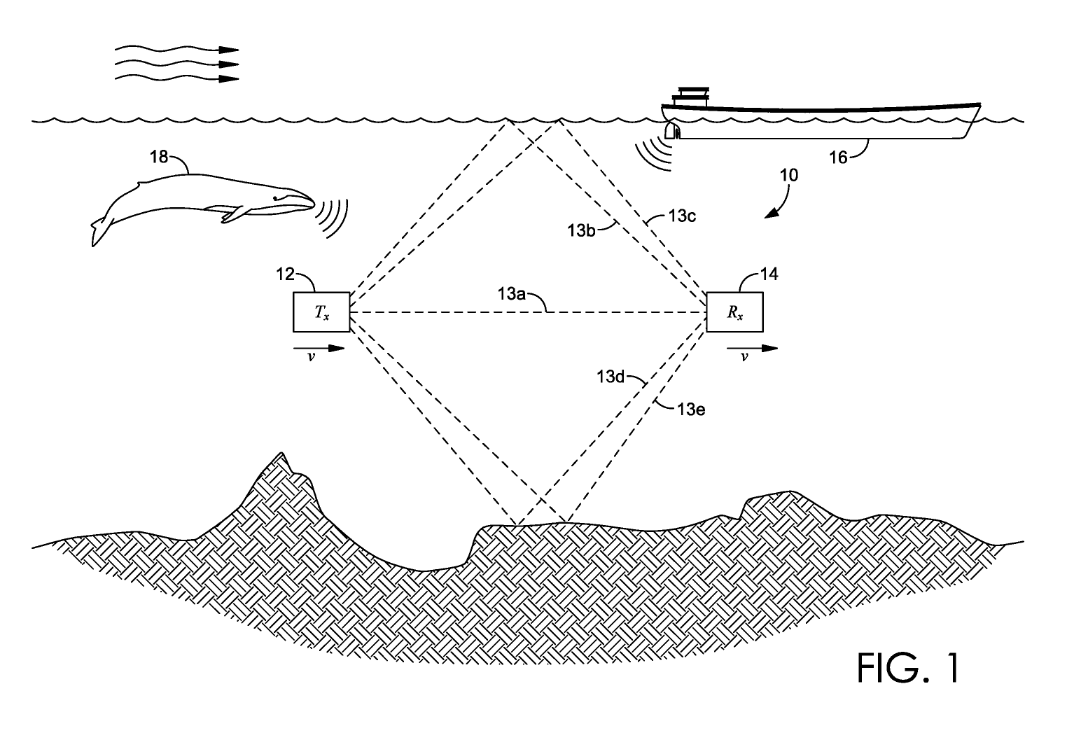

Turning now to the drawings and referring initially to FIG. 1, an exemplary operating environment is depicted for a point-to-point SISO UWA communication system 10. The illustrated system 10 is a single carrier modulation system having a single transmit projector and a single receive hydrophone. The system 10 includes a transmitter 12 that employs an interleaver and a channel encoder, which is configured to embed information bits into signals (e.g., signal 13a, 13b, 13c, 13d, 13e) and send the signals through to a SISO UWA channel. The system 10 further includes a turbo receiver 14 that is configured to receive signals (e.g., signal 13a, 13b, 13c, 13d, 13e) from the SISO UWA channel and decode the information bits.

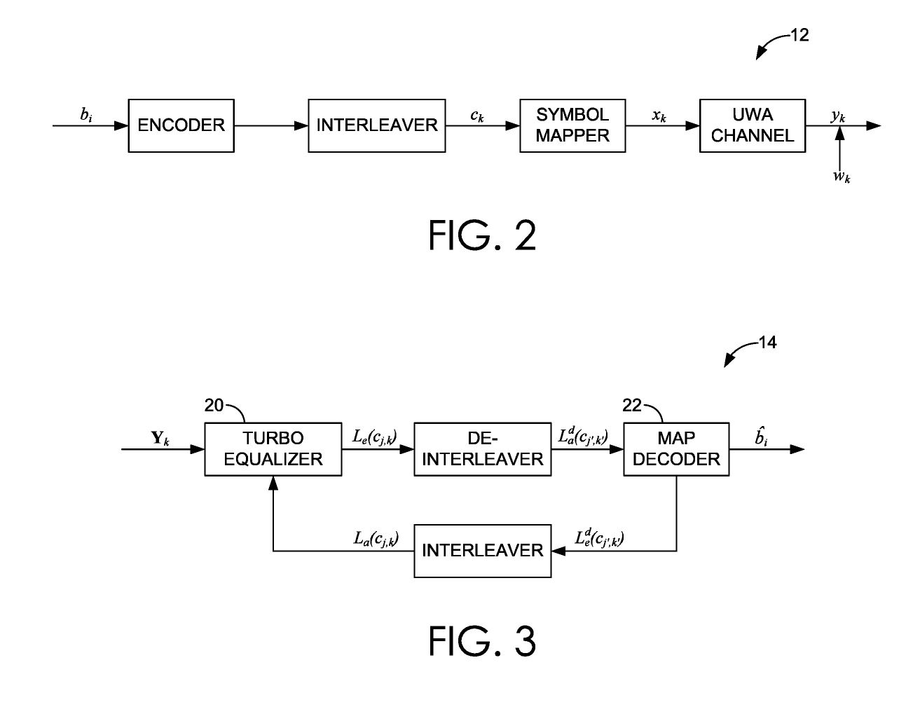

Turning to FIG. 2, a block diagram of the transmitter 12 of the system 10 is illustrated. The transmitter 12 is configured to encode and interleave a sequence of information bits {bᵢ}ᵢ₌₁^{K}^{_{b}}. The interleaved coded bits are grouped as c=[c₁ c₂ . . . c_{K}_{_{c}}], where cₖ denotes the kth coded bit vector [c_{k,1} c_{k,2} . . . c_{k,q}] with the jth bit c_{k,j}∈{0,1}. A symbol mapper maps each coded bit vector cₖ to a symbol xₖ from the 2^{q}-ary alphabet set S={∝₁, ∝₂, . . . , ∝₂_{^{q}}}, where ∝ᵢ corresponds to a deterministic bit pattern sᵢ=[s_{i,1}s_{i,2} . . . s_{i,q}] with s_{i,j}∈{0,1}. In other words, the symbol mapper maps a group of interleaved encoded bits with a specific symbol. After symbol mapping, the transmitter 12 is configured to upsample and pulse-shape a baseband signal. The pulse shaped signal is modulated with a single carrier and then transmitted to the SISO UWA channel.

Turning to FIG. 3, a block diagram of the turbo receiver 14 of the system 10 is illustrated. The turbo receiver 14 is configured to synchronize the received signal and demodulate it to baseband. After down sampling, the symbol rate received baseband signal at time instant k is determined by equation (1) below.

$${y}_{k} = {\sum }_{l = 0}^{L - 1} {h}_{l} {x}_{k - l} + {n}_{k} \qquad ( 1 )$$

In equation (1), hₗ is the lth tap of the length-L baseband equivalent UWA channel and xₖ₋ₗ is the symbol transmitted at time instant k−l. Also in equation (1), nₖ represents the sampled noise that is modeled as additive white Guassian noise with zero mean and variance σ_{w}². The sampled noise may include noise introduced by other factors present in or adjacent to the operating environment (e.g., FIG. 1), such as wind, shipping traffic (e.g., surface ship 16), and various forms of ocean life (e.g., whale 18 depicted in FIG. 1). Equation (1) can be rewritten in matrix form by stacking K=K₁+K₂+1 received symbols as a vector rₖ. Hence, in matrix form, equation (1) is rewritten as equation (2) below.

rₖ=Hxₖ+nₖ (2)

The vectors rₖ, xₖ, wₖ, and H from equation (2) are determined by equations (3a)-(3d), respectively, below.

$$\begin{matrix}{r}_{k} = {[ {y}_{k - {K}_{2}} {y}_{k - {K}_{2} + 1} ⋯ {y}_{k + {K}_{1}} ]}^{T} & ( 3 a ) \\ {x}_{k} = {[ {x}_{k - {K}_{2} - L + 1} {x}_{k - {K}_{2} - L + 2} ⋯ {x}_{k + {K}_{1}} ]}^{T} & ( 3 b ) \\ {w}_{k} = {[ {w}_{k - {K}_{2}} {w}_{k - {K}_{2} + 1} ⋯ {w}_{k + {K}_{1}} ]}^{T} & ( 3 c ) \\ H = [ \begin{matrix}{h}_{L - 1} & ⋯ & {h}_{0} & ⋯ & 0 \\ ⋮ & ⋱ & ⋱ & ⋱ & ⋮ \\ 0 & ⋯ & {h}_{L - 1} & ⋯ & {h}_{0}\end{matrix} ] & ( 3 d )\end{matrix}$$

The structure of the turbo receiver 14 is composed of two portions, a turbo equalizer 20 and a maximum a posterior probability (“MAP”) decoder 22. In contrast to the classic separate processing scheme, the turbo receiver 14 jointly performs the channel equalization and decoding in an iterative fashion. The turbo equalizer 20 estimates the transmitted symbol \hat{x}ₖ with the received signal and the a priori LLRs Lₐ(c_{k,j}) provided by the MAP decoder 22. The estimated symbol \hat{x}ₖ is then mapped to the bit extrinsic LLRs Lₑ (c_{k,j}). Next, the bit extrinsic LLRs Lₑ(c_{k,j}) are de-interleaved. After the de-interleaving operation, the bit extrinsic LLRs are transmitted to the MAP decoder 22 and treated as a priori information Lₐ^{d}(c_{k′,j′}) for MAP decoding. The MAP decoder 22 outputs corresponding bit extrinsic LLRs Lₑ^{d}(c_{k′,j′}), which are fed back to the turbo equalizer 20 (such as a SDFE as further described herein) as the next iteration bit a priori LLRs Lₐ(c_{k,j}). Based on the turbo principle, the extrinsic LLRs are iteratively determined using the turbo equalizer 20 and the MAP decoder 22. The reliability of the soft decisions (i.e., the estimated symbol of each iteration prior to a hard decision of the estimated symbol) progressively increases with the number of iterations. After a plurality of iterations, the iterative processing stops and a final hard decision of what bit \hat{b}ᵢ is represented by transmitted symbol \hat{x}ₖ is made by, and output from, the MAP decoder 22. In some aspects, the plurality of iterations may be set at a maximum number of iterations. In other aspects, the plurality of iterations may be determined based upon when the turbo equalizer has converged. For example, the change in LLRs may be used to determine whether the turbo equalizer has converged.

In some embodiments, the equalizer coefficients may be based on an estimated channel impulse response or directly estimated through adaptive methods. In embodiments using CE-based turbo receivers, an iterative channel estimation scheme may be utilized, which may be implemented via a Normalized Least Mean Square (“NLMS”) algorithm. The estimated UWA channel is then incorporated into the computation of the MMSE equalizer coefficients. In DA-TEQs, the NLMS algorithm may be used to directly estimate the equalizer coefficients without channel knowledge.

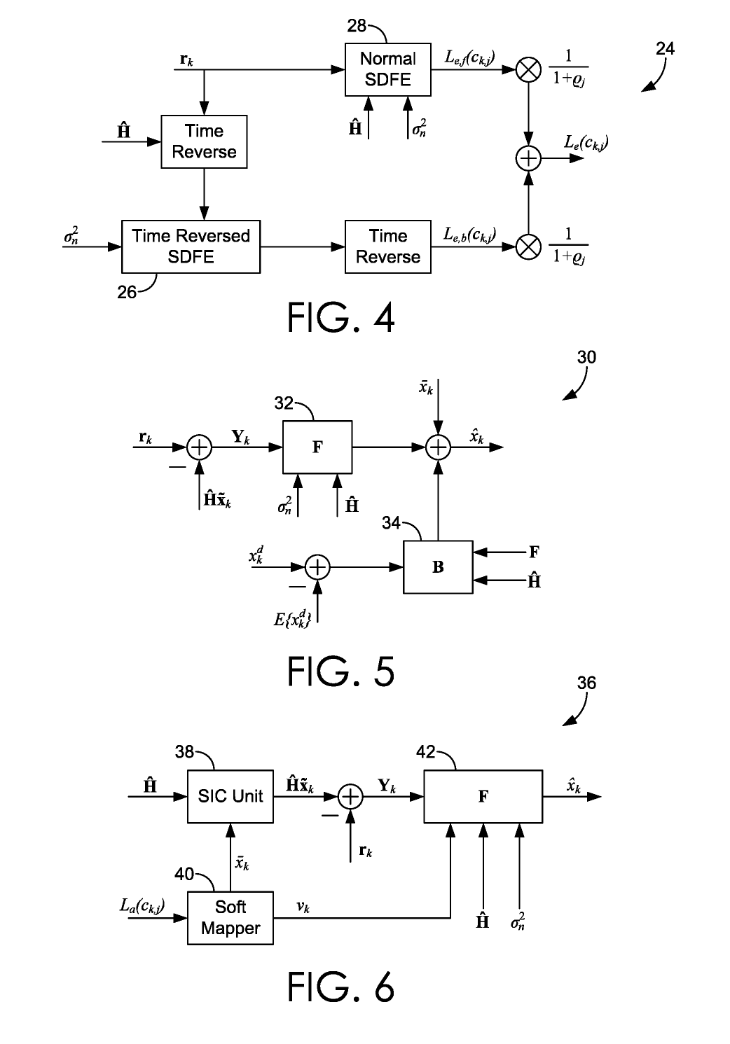

With continuing reference to FIG. 3 and reference to FIG. 4, various embodiments of turbo equalizers will now be discussed. In one embodiment, turbo equalizer 20 may comprise a CE-based Bi-SDFE, a CE-based SDFE, a CE-based LMMSE Turbo Equalizer, or a soft-decision direct-adaptation turbo equalizer (“Soft DA-TEQ”). In other aspects, other CE-based or direct-adaptation based turbo receivers may be utilized.

Referring now to FIG. 4, with continuing reference to FIG. 3, a block diagram of an exemplary Bi-SDFE 24 is depicted. The Bi-SDFE 24 uses a time-reversed SDFE 26 in conjunction with a Normal SDFE 28 to harvest the time-reverse diversity in decision feedback equalization. In some aspects, both the time-reversed SDFE 26 and the normal SDFE 28 may be the low-complexity implemented SDFE (as further described in FIG. 5). A linear combining scheme may be adopted to combine the extrinsic LLRs output from the time-reversed SDFE 26 (e.g, L_{e,b}(c_{k,j})) and the normal SDFE 28 (e.g, L_{e,f}(c_{k,j})). For example, equation (4) may be used to combine the extrinsic LLRs output from the time-reversed SDFE 26 and the normal SDFE 28.

$${L}_{e} ( {c}_{k , j} ) = \frac{1}{1 + {ϱ}_{j}} ( {L}_{e , f} ( {c}_{k , j} ) + {L}_{e , b} ( {c}_{k , j} ) ) \qquad ( 4 )$$

In equation (4), L_{e,b}(c_{k,j}) and Lₑ(c_{k,j}), respectively, represent the extrinsic LLRs from the time-reversed SDFE 26 and the normal SDFE 28 for the same bit index j, and [symbol] ⱼ represents the correlation coefficient estimated by time averaging and may be determined with equation (5) below. Similarly, the mean vector \hat{μ}_{j,f} and \hat{μ}_{j,b} of the outputs of the normal SDFE 28 and the time-reversed SDFE 26 may also be estimated by time averaging.

$${\hat{ϱ}}_{j} = \frac{{Σ}_{k = 1}^{{K}_{c}} [ {L}_{e , f} ( {c}_{k , j} ) - {\hat{μ}}_{j , f} ] [ {L}_{e , b} ( {c}_{k , j} ) - {\hat{μ}}_{j , b} ]}{( {K}_{c} - 1 ) {\hat{σ}}_{j , f} {\hat{σ}}_{j , b}} \qquad ( 5 )$$

Referring now to FIG. 5, with continuing reference to FIG. 3, a block diagram of an exemplary SDFE 30 is depicted. The exemplary SDFE 30 may include a feedforward filter 32 and a feedback filter 34. As illustrated, a received signal rₖ is combined with a serial interference canceller Ĥ\tilde{x}ₖ prior to the feedforward filter 32. In addition to the combined received signal and serial interference canceller, an estimated noise variance σₙ² and an estimated channel matrix Ĥ are used to adapt the coefficients g of the feedforward filter 32. An input vector xₖ^{d} is combined with a time-averaged input vector E{xₖ^{d}} prior to the feedback filter 34. In addition, one or more feedforward filter coefficients F and the estimated channel matrix Ĥ are used to adapt the coefficients B of the feedback filter 34. The output from the feedforward filter 32 is combined with the output from the feedback filter 34 and also combined with an a priori soft decision x̅ₖ to generate an estimated symbol \hat{x}ₖ. The estimated symbol \hat{x}ₖ may be determined with equation (6) below, where dₖ is the time-varying offset. Further, the input vector xₖ^{d} may be determined with equation (7) below, where the xₖ^{d} is an a posteriori soft decision.

\hat{x}ₖ=Rrₖ+Bxₖ^{d}+dₖ (6)

xₖ^{d}=[x_{k-K}_{₃}^{d} x_{k-K}_{₃}₊₁^{d} . . . xₖ₋₁^{d}]^{T} (7)

In a second embodiment, the turbo equalizer 20 may comprise a CE-based SDFE. For example, the CE-based SDFE may comprise the exemplary SDFE 30 discussed above in reference to FIG. 5. An estimated symbol \hat{x}ₖ may be determined by equation (6) where F is the feedforward filter, B is the feedback filter of length K₃=K₂+L−1, and dₖ is the time-varying offset. The input vector of the feedback filter is defined by equation (7) where xₖ^{d} is the a posteriori soft decision estimated by combining the a priori LLRs Lₐ (c_{k,j}) and bit extrinsic LLRs Lₑ(c_{k,j}). The filters in the exemplary SDFE 30 at each turbo iteration are determined by equations (8a)-(8c) below, where C^{ff}, C^{fb} and C^{bb} are the covariance matrices.

F^{H}=[σ_{w}²I_{K}+Ĥ(C^{ff}−C^{fb}(C^{bb})⁻¹C^{fbH})Ĥ^{H}]⁻¹ (8a)

B^{H}=−(C^{bb})⁻¹ĤC^{fbH}F^{H} (8b)

dₖ=E{xₖ}−FĤE{xₖ}−BE{xₖ^{d}} (8c)

The covariance matrices C^{ff}, C^{fb}, and C^{bb} are defined by equations (9a)-(9c) below.

C^{ff}=E{xₖxₖ^{H}}−E{xₖ}E{xₖ^{H}} (9a)

C^{fb}=E{xₖxₖ^{d}^{^{H}}}−E{xₖ}E{xₖ^{d}^{^{H}}} (9b)

C^{bb}=E{xₖ^{d}xₖ^{d}^{^{H}}}−E{ₓ^{d}}E{xₖ^{d}^{^{H}}} (9c)

The covariance matrices C^{ff}, C^{fb} and C^{bb} are computed with the a priori LLRs and the a posteriori LLRs. The selection vector s is defined as s=Ĥ[0_{1×(K}_{₂}_{+L-1)}I_{K}0_{1×(K}_{₁}₎]^{T}.

In a third embodiment, the turbo equalizer 20 may comprise a CE-based LMMSE turbo equalizer that estimates the transmitted symbol \hat{x}ₖ using the received signal rₖ and the a priori LLRs Lₐ (c_{k,j}) provided by the MAP decoder 22. Turning to FIG. 6, with continuing reference to FIG. 3, a block diagram of an exemplary CE-based LMMSE turbo equalizer 36 is depicted. The exemplary CE-based LMMSE turbo equalizer 36 includes a serial interference cancellation (“SIC”) unit 38, a soft mapper 40, and a feedforward filter 42. The a priori information Lₐ (c_{k,j}) is provided to the soft mapper 40, which uses the a priori LLRs Lₐ(c_{k,j}) to compute an a priori soft decision 4. The a priori soft decision may be determined by equations (10) and (11) below.

$$\begin{matrix}{\overline{x}}_{k} = E [ {x}_{k} \vert {\{ {L}_{a} ( {c}_{k , j} ) \}}_{j = 1}^{Q} ] = {\sum }_{{α}_{i} ∈ S} {α}_{i} P ( {x}_{k} = {α}_{i} ) \\ where & ( 10 ) \\ P ( {x}_{k} = {α}_{i} ) = {\prod }_{j = 1}^{q} \frac{1}{2} ( 1 + {\tilde{s}}_{i , j} tanh ( {L}_{a} ( {c}_{k , j} ) \text{/} 2 ) ) \\ and \\ {\tilde{s}}_{i , j} = \{ \begin{matrix}+ 1 & if {s}_{i , j} = 0 \\ - 1 & if {s}_{i , j} = 1.\end{matrix} & ( 11 )\end{matrix}$$

The a priori soft decision x̅ₖ is fed into the SIC unit 38 along with an estimated channel Ĥ and a reconstructed interference Ĥ\tilde{x}ₖ is output. The reconstructed Ĥ\tilde{x}ₖ is subtracted from the received signal rₖ and fed into the feedforward filter 42. The feedforward filter 42 is adapted by the estimated covariance vₖ, the estimated channel Ĥ, and an estimated noise variance σₙ². The transmitted symbol xₖ is estimated by a linear combining of the received signals and the a priori soft decisions. The estimated transmitted symbol \hat{x}ₖ is determined with equation (12) below.

\hat{x}ₖ=F^{H}(rₖ−Ĥ\tilde{x}ₖ) (12)

In equation (12), the received signal rₖ is defined by equation (3a) above, F is the feedforward filter with length K=k₁+k₂+1, Ĥ is the estimated channel matrix, and the masked symbol vector \tilde{x}ₖ is defined as \tilde{x}ₖ=[x̅_{k-K}_{₂}_{-L+1} . . . x̅ₖ₋₁ 0 x̅ₖ₊₁ . . . x̅_{k+K}_{₁}]^{T}.

In some aspects, due to the computational complexity, the feedforward filter is computed only once during each turbo iteration. The feedforward filter is determined by equation (13) below, where v̅ is the time averaged variances of the transmitted symbols that is computed based on the a priori LLRs and \tilde{h}ₖ is the (K₂+L)th column of the estimated channel Ĥ.

F=(σ_{w}²I_{K}+v̅ĤĤ^{H})⁻¹\tilde{h}ₖ (13)

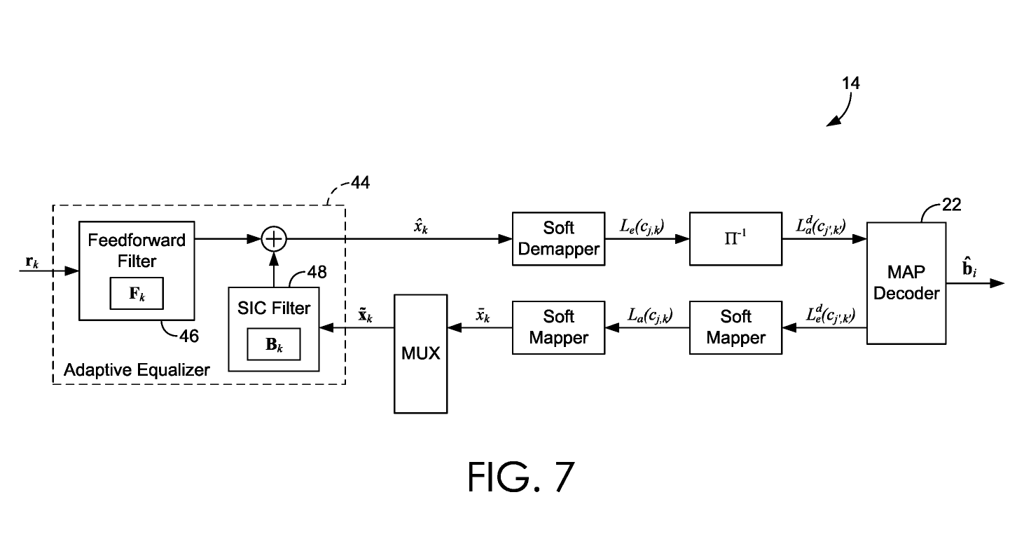

In a fourth embodiment, the turbo equalizer 20 may comprise a Soft DA-TEQ that estimates the transmitted symbol \hat{x}ₖ using the received signal rₖ and the a priori soft decisions Lₐ(c_{k,j}) provided by the MAP decoder 22. Turning now to FIG. 7, a block diagram of a turbo receiver having an exemplary Soft DA-TEQ 44 is depicted. The exemplary Soft DA-TEQ includes a feedforward filter 46 and a soft interference cancellation filter 48. The estimated transmitted symbol \hat{x}ₖ may be determined with equation (14) below, where Fₖ is the feedforward filter and Bₖ is the soft interference cancellation filter.

\hat{x}ₖ=Fₖ^{H}rₖ+Bₖ^{H}\tilde{x}ₖ (14)

Equation (13) can be reformulated as \hat{x}ₖ=Gₖ^{H}Uₖ, where Gₖ=[Fₖ^{T} Bₖ^{T}]^{T} is the concatenation of the feedforward and soft interference filters, and Uₖ=[rₖ^{T} \tilde{x}ₖ^{T}]^{T} is the overall input of said filters. The equalizer coefficients may be directly estimated by the DA-TEQ utilizing an adaptive algorithm (e.g., NLMS) such as the adaptive algorithm set forth in equation (15) below.

$${G}_{k + 1} = {G}_{k} + 2 \frac{μ}{ϵ + {r}_{k} {r}_{k}^{H}} ( {x}_{k} - {( {G}_{k} )}^{H} {U}_{k} ) {U}_{k} \qquad ( 15 )$$

In equation (15), μ is the step size and E is a small number for regularization.

To track time variations of the UWA channels, in one aspect the filter adaptation continues in decision-directed mode after a training phase. In decision-directed mode the training symbol xₖ (used in training-mode) in equation (14) is replaced with a tentative hard decision \hat{x}ₖ. Such an empirical process has been widely used in prior art DA-TEQs. This prior art empirical process suffers from a significant drawback; however, hard decision directed adaptation has significant error propagation that may result in a catastrophic failure of the convergence. Hence, an aspect of the present invention is directed to a Soft DA-TEQ that utilizes the a priori soft decision x̅ₖ from the MAP decoder 22 (shown in FIG. 3) to direct the equalizer coefficients adaptation. A MAP decoder 22 is seen in FIGS. 3 and 7 and disclosed as comprising various embodiments herein; however, in aspects, the MAP decoder 22 may be replaced or supplemented by a soft-decision decoder.

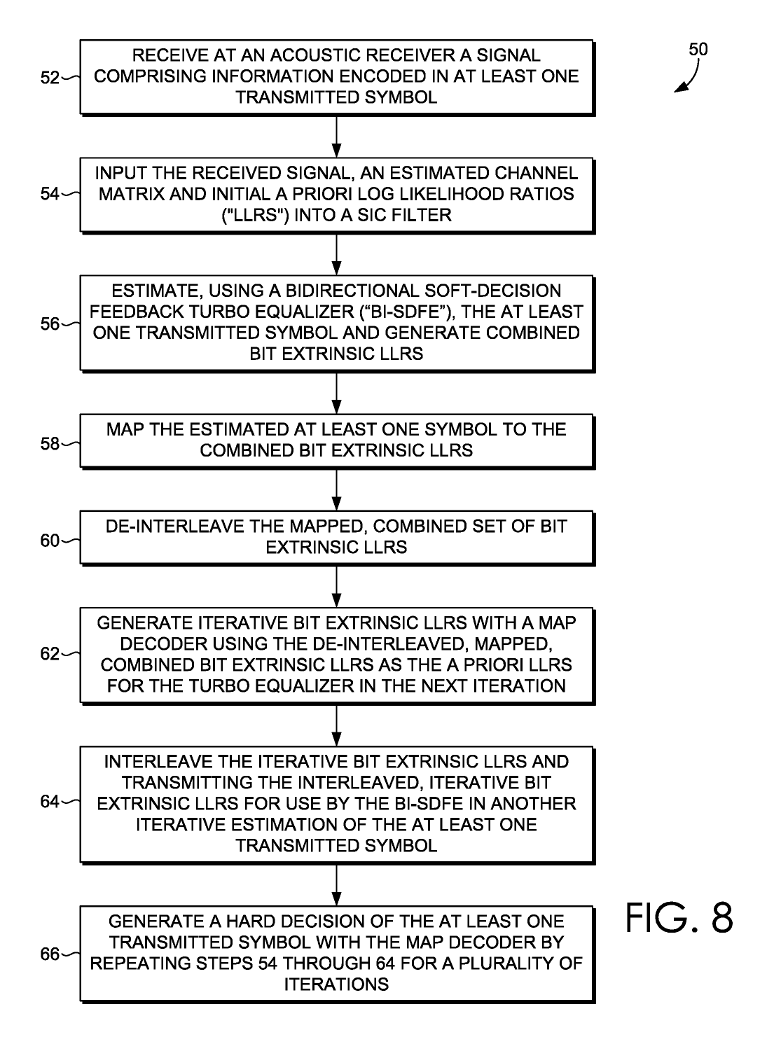

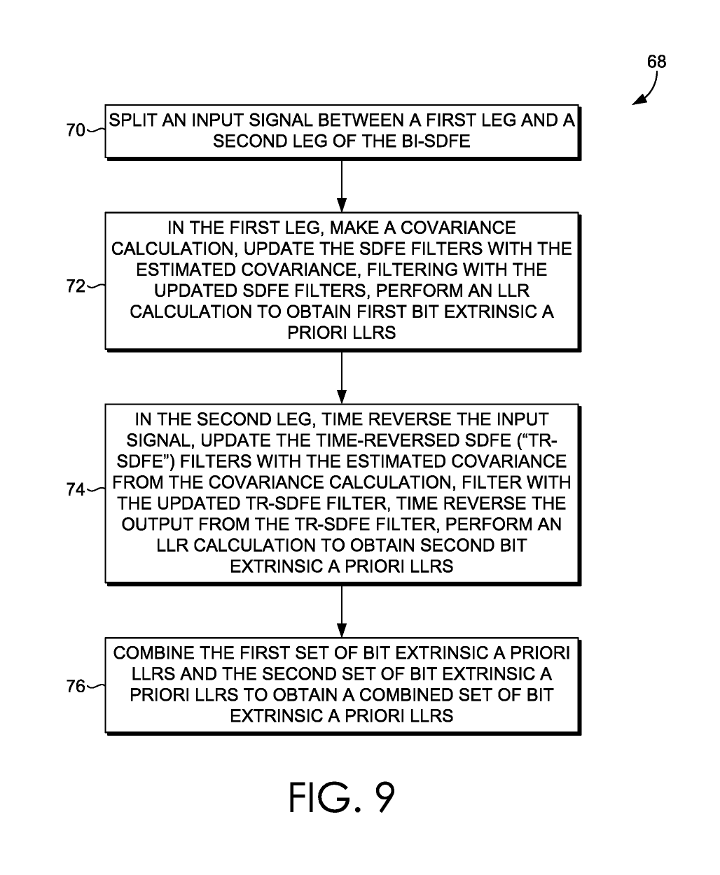

Turning now to FIG. 8, an exemplary method 50 for underwater communication using SISO acoustic channel will now be discussed. The method 50 may include the step 52 of receiving, at an acoustic receiver, a signal comprising information encoded in at least one transmitted symbol. The method 50 may further include the step 54 of inputting the received signal, an estimated channel matrix, and initial a priori LLRs into a SIC filter. The method 50 may also include the step 56 of estimating, using a Bi-SDFE, the at least one transmitted symbol and a priori LLRs. The Bi-SDFE may comprise a SDFE and a time-reversed SDFE that each output bit extrinsic LLRs that are combined into combined bit extrinsic LLRs (e.g., as in equation (4) above). In some aspects, the method 50 may further include adding the estimated a priori LLRs to the combined bit extrinsic LLRs to obtain first a posteriori LLRs. In other aspects, the step 56 may comprise the method for estimating described below in relation to FIG. 9. The method 50 may further include the step 58 of mapping the estimated, transmitted symbol to the combined bit extrinsic LLRs. The method 50 may also include the step 60 of de-interleaving the mapped, combined bit extrinsic LLRs. In other aspects, the method 50 may also include the step of de-interleaving the first a posteriori LLRs. The method 50 may further include the step 62 of generating iterative bit extrinsic LLRs with a soft-decision decoder using the de-interleaved, mapped, combined bit extrinsic LLRs and the estimated a priori LLRs for the turbo equalizer in the next iteration information. In other aspects, the method 50 may include the step of generating iterative bit extrinsic LLRs with the soft-decision decoder and adding the iterative bit extrinsic LLRs to the estimated a priori LLRs to obtain second a posteriori LLRs. The method 50 may include the step 64 of interleaving the iterative bit extrinsic LLRs and transmitting the interleaved, iterative bit extrinsic LLRs for use by the Bi-SDFE in another iterative estimation of the at least one transmitted symbol. In other aspects, the step 64 may interleave the second a posteriori LLRs. The method 50 may include the step 66 of generating a hard decision of the one of the at least one transmitted symbol with the soft-decision decoder by repeating steps 48-58 for a plurality of iterations.

Turning now to FIG. 9, an exemplary method 68 for estimating, using a Bi-SDFE, a transmitted symbol encoded on a received signal will now be discussed. The method 68 may include the step 70 of feeding an input signal Yₖ to each of a first leg and a second leg of the Bi-SDFE. The method 68 may include the step 72 of, in the first leg, calculating a covariance matrix, updating the SDFE filters with the estimated covariance v̅, filtering with the updated SDFE filters F and B, and calculating an LLR to obtain a first set of bit extrinsic LLRs. The method 68 may include the step 74 of, in the second leg, time reversing the input signal Yₖ, updating the time-reversed SDFE filter with the estimated covariance v̅ from the covariance calculation, filtering the time-reversed input signal Y_{bk} with the updated time-reversed SDFE filters F_{b} and B_{b} and time reversing the output from the time-reversed SDFE, and calculating an LLR to obtain a second set of bit extrinsic LLRs. The method 68 may include the step 76 of combining the first bit extrinsic LLRs and the second bit extrinsic LLRs to obtain a combined bit extrinsic LLRs.

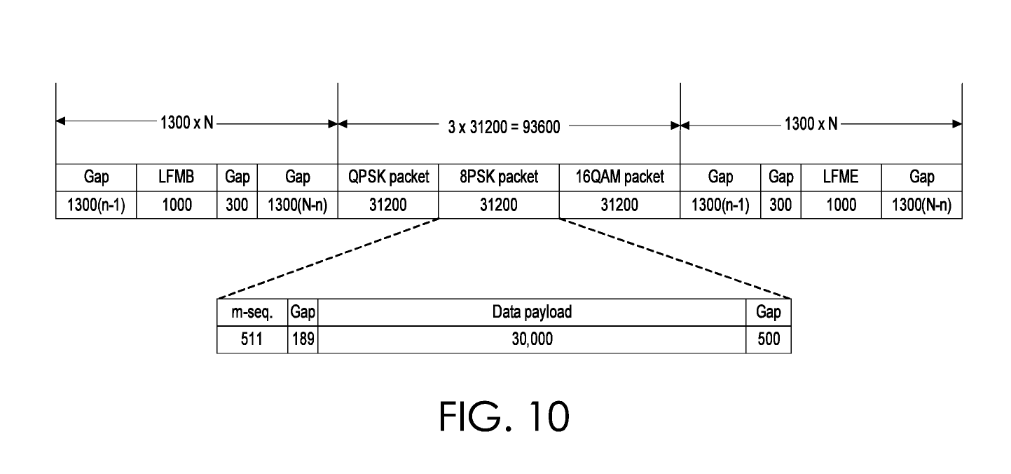

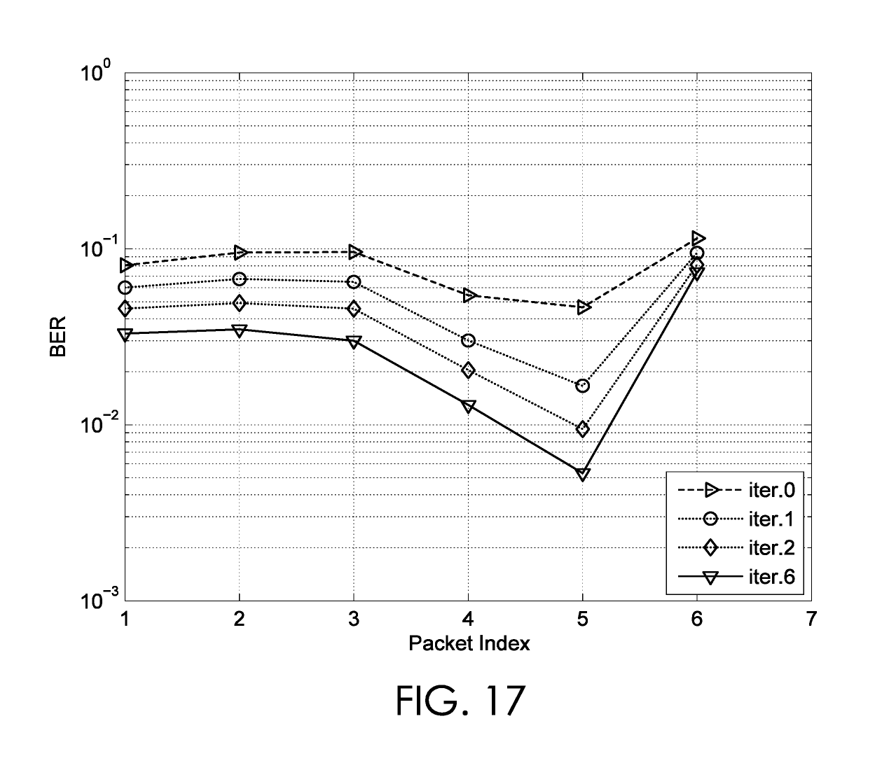

Reference will now be made to FIGS. 10-17. The above described systems and methods were tested using data obtained from more than ten ocean experiments. The results from the SPACE08 experiment are presented in FIGS. 10-17. The SPACE08 experiment was conducted at the coast of Martha's Vineyard, Edgartown, Mass., in October 2008. A single carrier modulation frame structure, such as that shown in FIG. 9, was adopted for transmission. The data frame consisted of a header, three data packets, and a tail. The header and tail of the transmitted signal were LFMB and LFME, respectively, each having a 1000-symbol length of linear frequency modulation (“LFM”) signal surrounded by some gaps. The header and tail were for Doppler estimation, frame synchronization, and carrier synchronization purposes. The three data packets were QPSK, 8PSK, and 16QAM modulated symbols, respectively. The transmission signal strength was the same for all three modulation schemes, making the received signal-to-noise ratio (“SNR”) the same for all modulation schemes. Each packet started with an m-sequence (maximal-length sequence) of length 511, followed by a small gap and a data packet of 30,000 symbols. In FIG. 10, N represents the number of transducers, and n is the transducer index. For SISO transmission, both N and n are set as 1.

A rate ½ convolutional code with a generator polynomial G=[17, 13]_{oct} was chosen as the forward error correction code. The center carrier frequency was f_{c}=13 kHz. The symbol interval was 0.1024 ms, and the roll-off factor for the square-root raised cosine pulse shaping filter was chosen as β=0.2. Thus, the occupied bandwidth of the transmitted signal was 11.71875 kHz. The receiver sampling rate was 39.0625 kilo-samples/s. The communication distance was 200 meters.

The depth of the experimental water was about 15 m. A transducer located on a fixed tripod at about 4 m above the ocean bottom was used in the SISO communication test. At the receiver, 24 hydrophones were also fixed with tripods to form a vertical array, where the top hydrophone of the array was about 3.3 m above the ocean bottom. The sixth hydrophone from the top was used to form the SISO communication system. Seven received data frames at different transmission times from the SPACE08 experiment were processed to test the performance of the turbo receivers described herein above in SISO UWA channels.

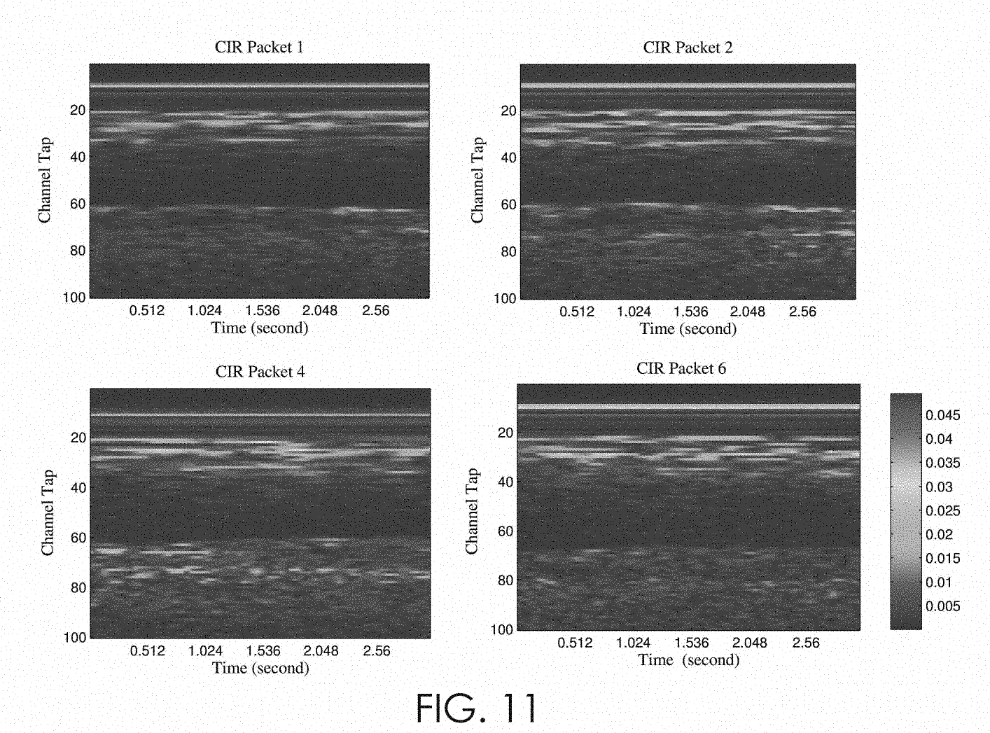

FIG. 11 shows the time evolution of four typical channel impulse responses (“CIRs”) in the experiment. The CIRs were fast time-varying, although both the transducer and hydrophone were fixed during the experiment. In some packet transmissions, the channels were also non-minimum phase systems since the strongest multipath components were not located at the very beginning of the CIR.

The performance of the four embodiments of the turbo equalizers described above (i.e., the Bi-SDFE, the SDFE, the LMMSE and the Soft DA-TEQ) will now be discussed. First, the performance of the three channel estimation based turbo equalizers will be discussed. Next, the performance of the direct adaptation turbo equalizer will be discussed.

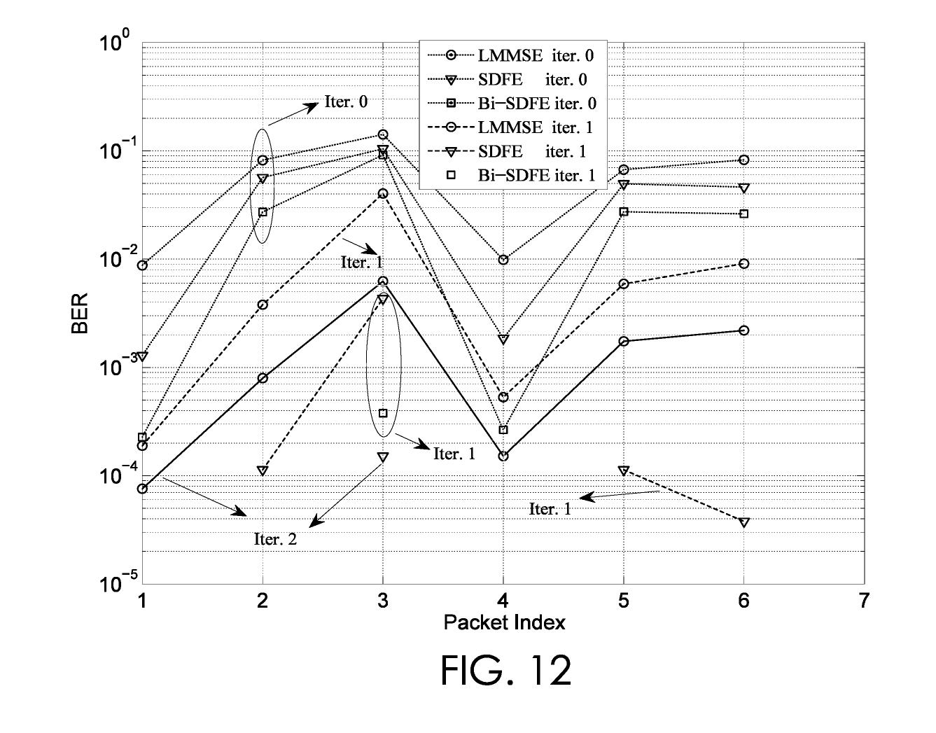

The Bit-Error-Rate (“BER”) performance of the CE-based turbo receivers is shown in FIGS. 12-14. Note that “iter. 0” denotes the non-iterative processing, i.e., one-time equalization and one-time decoding. The packets with 0 BER are not shown in FIGS. 12-14 due to the log scale.

The BER of the CE-based turbo receivers when using QPSK is compared in FIG. 12. The pilot overhead was set as 12%. It was observed that after only one iteration of turbo equalization significant performance gain over the non-iterative equalizers was achieved. This performance gain was particularly evident for the Bi-SDFE, which achieved 0 BER for six packets with only one iteration. By the second iteration, the SDFE and the Bi-SDFE achieved 0 BER for six and seven packets, respectively. The LMMSE turbo equalizer converged slowest with only one packet achieving 0 BER after two iterations. Hence, with QPSK modulations, it was observed that both the SDFE and Bi-SDFE turbo equalizers enabled robust SISO UWA single carrier transmission.

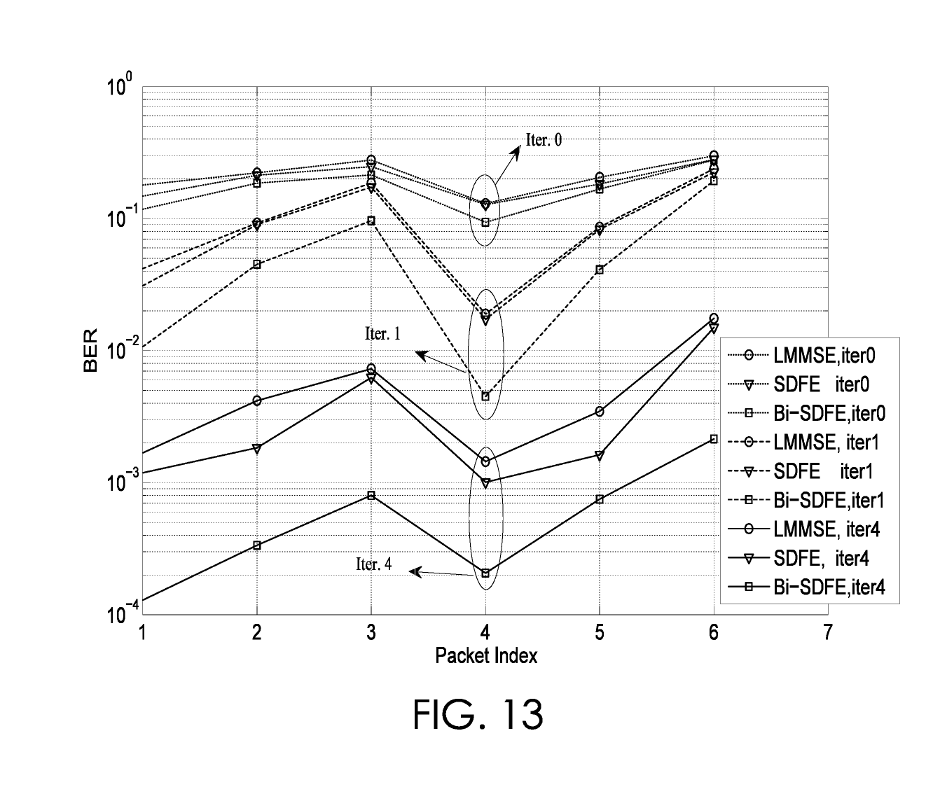

The BER of the CE-based turbo receivers when using 8PSK modulation is compared in FIG. 13. The pilot overhead was set as 14.81%. The iterative processing was observed to provide tremendous performance improvement over the one-time equalization and decoding of non-iterative equalizers. The Bi-SDFE equalizer has observable performance gain over the SDFE and LMMSE equalizers. After four iterations, the Bi-SDFE achieved one packet with 0 BER, five packets with BER level 1e-4, and one packet with BER level 1e-3.

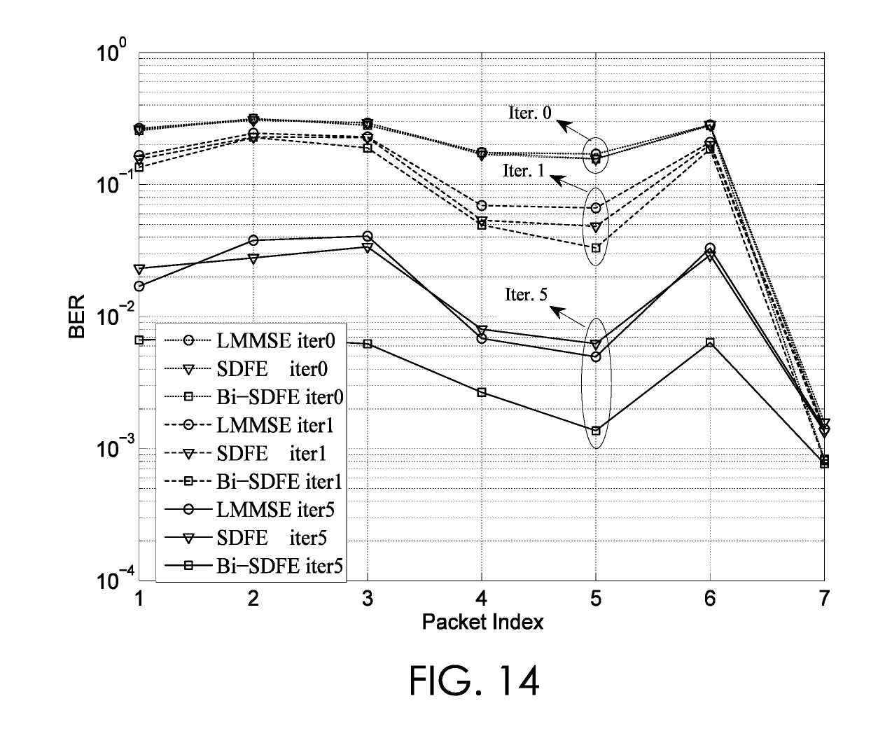

The BER of the CE-based turbo receivers when using 16QAM modulation is compared in FIG. 14. The pilot overhead was set as 22.22%. The performance trends among the three channel estimation based turbo equalizers was observed to be very similar to that observed with the 8PSK transmission. After five iterations, the Bi-SDFE achieved a BER level of 1e-3 for most packets. It was also observed that the performance gap between the SDFE and LMSSE equalizers was very minor, even after multiple iterations. It was further observed, that for packet 7 (good channel condition), the iterative algorithm exhibited no improvement in BER with successive iterations.

Overall, the QPSK and 8PSK transmissions with the three channel estimation based turbo equalizers were robust in SISO UWA channels. The turbo receivers achieved low level of BERs, even with low pilot overhead. The single carrier transmission with 16QAM modulation in SISO transmission is challenging dues to their low E_{b}/N₀. The Bi-SDFE was observed to greatly enhance the system's performance.

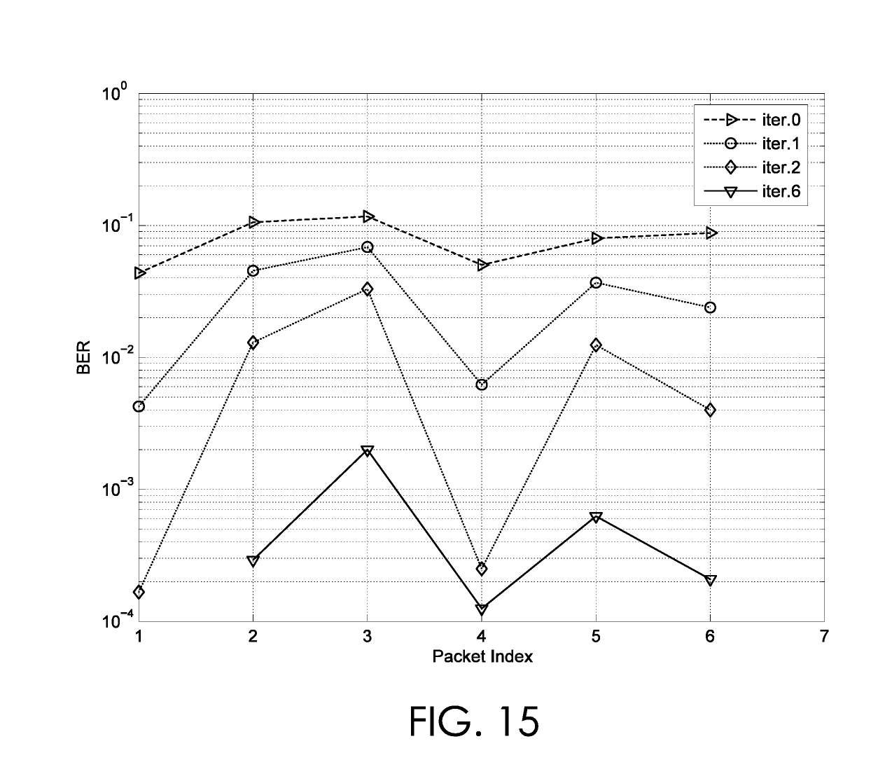

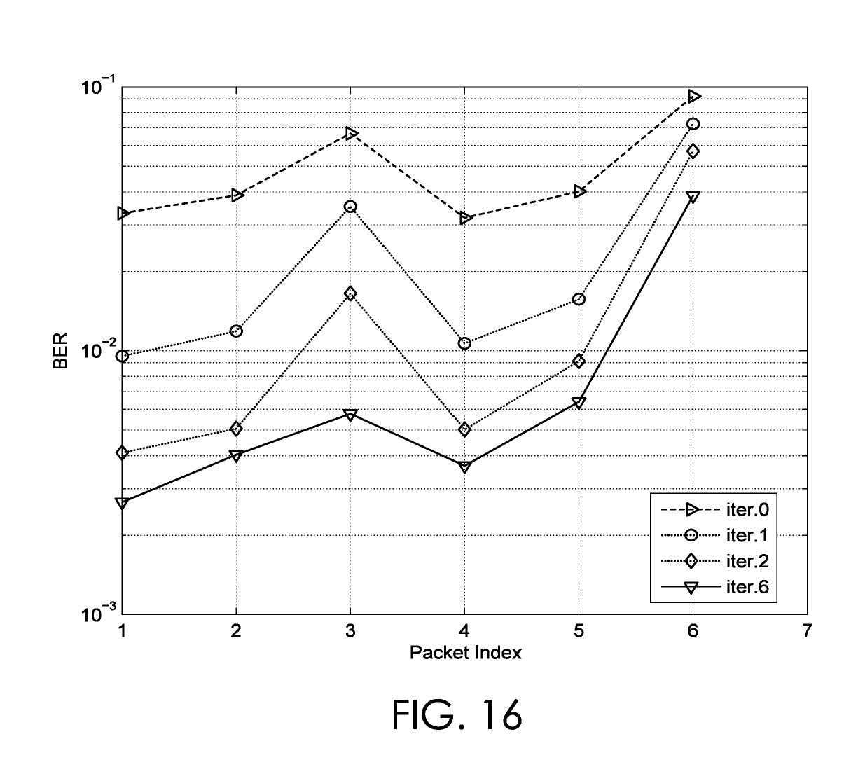

The BER performance of the Soft DA-TEQ in SISO UWA channels is shown in FIGS. 15-17. The BER of the Soft DA-TEQ turbo receiver when using QPSK is shown in FIG. 15. For QPSK, 20% pilot overhead was required to achieve low BER performance. It was observed that packet 1 and 7 achieved 0 BER and four packets achieved a BER level of 1e-4. Only packet 3 stayed at the BER level 1e-3 after multiple iterations. It was observed for higher lever modulations that the Soft DA-TEQ required much higher pilot overhead to achieve satisfactory performance. For example, when 8PSK modulation was used pilot overhead was set at 30% to achieve the results shown in FIG. 16. When 16QAM modulation was used, pilot overhead was set at 42% and which showed minimal convergence. Hence, the Soft DA-TEQ equalizer with high level modulations may be spectrally inefficient in time-varying SISO UWA channels. However, with QPSK modulation, the Soft DA-TEQ may achieve a good trade-off between complexity and performance with a reasonable percentage of pilot overhead.

It was also noted that packet 7 achieved 0 BER at iteration 0 for all modulation schemes, but the overhead was a lot higher than the channel estimation based turbo equalizers. When the overhead was reduced to the same levels it was set for the tests of the channel estimation based turbo equalizers, the Soft DA-TEQ of packet 7 performed similarly to the channel estimation based algorithms.

The experimental results of testing the four MMSE-TEQs in time-varying SISO UWA channels show that the channel estimation based turbo equalizers are robust in SISO UWA transmission under harsh channel conditions. With reasonable pilot overhead, the Bi-SDFE was observed to achieve the lowest BER performance in all channels with slightly higher computational complexity. In contrast, the Soft DA-TEQ exhibited low complexity but was observed to require high pilot overhead to achieve satisfactory BER performance. The pilot overhead of the Soft DA-TEQ was observed to be especially high in high-level modulation schemes, making the high-level modulation unattractive in low SNR conditions. Overall, it was observed that the QPSK modulation can achieve extraordinary low BER performance for all channel estimation based turbo equalizers and Soft DA-TEQ algorithms in all packets because of the reasonable SNR levels.

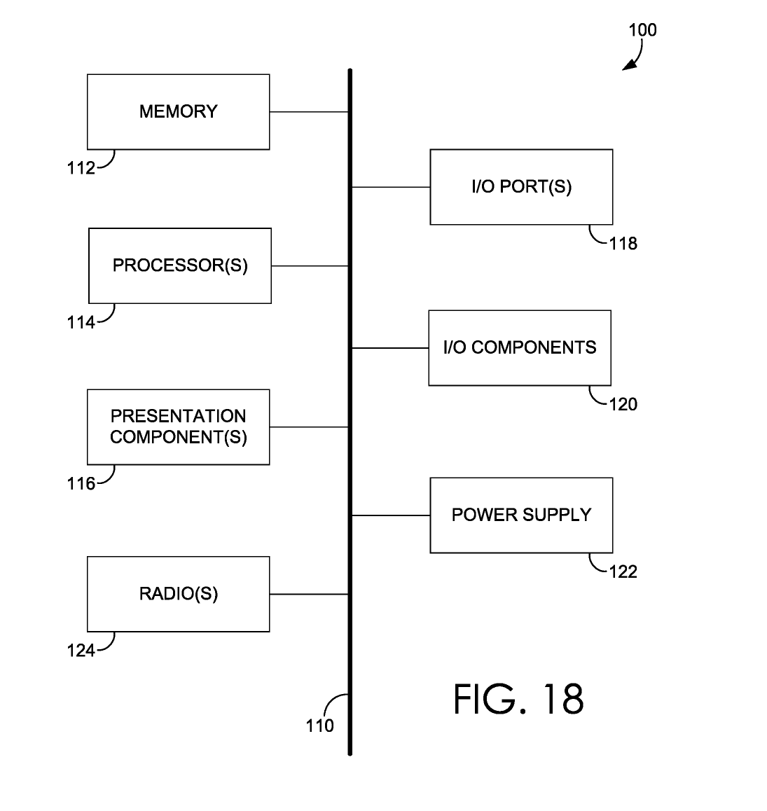

The technology herein described may comprise, among other things, a SISO UWA modem, a single carrier system with bit-interleaved coded modulation for point-to-point SISO UWA transmissions, and a method or a set of instructions stored on one or more computer-readable media. Information stored on the computer-readable media may be used to direct operations of a computing device, and an exemplary computing device 100 is depicted in FIG. 18. The computing device 100 is but one example of a suitable computing system and is not intended to suggest any limitation as to the scope of use or functionality of inventive aspects hereof. Neither should the computing system 100 be interpreted as having any dependency or requirement relating to any one or combination of components illustrated. Moreover, aspects of the invention may also be practiced in distributed computing systems where tasks are performed by separate or remote-processing devices that are linked through a communications network.

The computing device 100 has a bus 110 that directly or indirectly couples the following components: memory 112 (which may include memory chips or other local memory structures), one or more processors 114 (which may include a programmable logic controller), one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 18 are shown with lines for the sake of clarity, in reality, delineating various components is not so clear, and metaphorically, the lines would more accurately be grey and fuzzy. For example, processors may have memory. Further, it will be understood by those of ordinary skill in the art that not all computing devices contemplated for use with aspects hereof may utilize all components illustrated.

The computing device 100 typically includes a variety of computer-readable media. Computer-readable media can be any available media that can be accessed by the computing system 100 and includes both volatile and nonvolatile media, removable and non-removable media. By way of example, and not limitation, computer-readable media may comprise computer storage media and communication media; computer storage media excluding signals per se. Computer storage media includes volatile and nonvolatile, removable and non-removable media implemented in any method or technology for storage of information such as computer-readable instructions, data structures, program modules or other data.

Computer storage media includes, by way of example, and not limitation, Random Access Memory (RAM); Read Only Memory (ROM); Electronically Erasable Programmable Read Only Memory (EEPROM); flash memory or other memory technologies; CD-ROM, digital versatile disks (DVD) or other optical or holographic media; magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of communications media.

The computing device 100 is depicted to have one or more processors 114 that read data from various entities such as memory 112 or I/O components 120. Exemplary data that is read by a processor may be comprised of computer code or machine-useable instructions, which may be computer-executable instructions such as program modules, being executed by a computer or other machine. Generally, program modules such as routines, programs, objects, components, data structures, etc., refer to code that perform particular tasks or implement particular abstract data types.

The presentation components 116 present data indications to a user or other device. Exemplary presentation components are a display device, speaker, printing component, light-emitting component, etc. The I/O ports 118 allow the computing device 100 to be logically coupled to other devices including the I/O components 120, some of which may be built in.

In the context of SISO UWA communications, a computing device 100 may be used to process the received signals and compute the algorithms associated with the turbo receivers. For example, a computing device may be used to perform the iterative method of channel equalization and decoding of SISO UWA communications described herein.

The foregoing description has described the systems and methods of the present invention in terms of SISO UWA communications for the purposes of concision. It would be understood by artisans skilled in the relevant art, however, that the above described systems and methods may also be used for single-input multiple-output (“SIMO”) UWA communications and multiple-input multiple-output (“MIMO”) UWA communications.

From the foregoing, it will be seen that aspects described herein are well adapted to attain all of the ends and objects hereinabove set forth, together with other advantages which are obvious and which are inherent to the structure. It will be understood that certain features and subcombinations are of utility and may be employed without reference to other features and subcombinations. This is contemplated by and is within the scope of the claims. Since many possible aspects described herein may be made without departing from the scope thereof, it is to be understood that all matter herein set forth or shown in the accompanying drawings is to be interpreted as illustrative and not in a limiting sense.

What is claimed is:

1. A method for underwater communication using a acoustic channel, the method comprising:
(a) receiving at an acoustic receiver a signal comprising information encoded in at least one transmitted symbol;
(b) estimating, using a turbo equalizer, the at least one transmitted symbol and a priori log likelihood ratios (“LLRs”), wherein the turbo equalizer comprises a SDFE and a time-reversed SDFE that each output bit extrinsic LLRs that are combined into combined bit extrinsic LLRs;
(c) mapping the estimated, transmitted symbol to the combined bit extrinsic LLRs;
(d) adding the estimated a priori LLRs to the combined bit extrinsic LLRs to obtain first a posteriori LLRs;
(d) de-interleaving the first a posteriori LLRs;
(e) generating iterative bit extrinsic LLRs with a MAP decoder;
(f) adding the iterative bit extrinsic LLRs to the estimated a priori LLRs to obtain second a posteriori LLRs;
(g) interleaving the second a posteriori LLRs for use by the turbo equalizer in another iterative estimation of the at least one transmitted symbol; and
(h) generating a hard decision of the transmitted symbol with the MAP decoder by repeating steps (b) through (g) for a plurality of iterations.

2. The method of claim 1, wherein the signal includes one or more data packets comprising QPSK modulated symbols.

3. The method of claim 1, wherein the signal includes one or more data packets comprising 8PSK modulated symbols.

4. The method of claim 1, wherein the signal includes one or more data packets comprising 16QAM modulated symbols.

5. The method of claim 1 further comprising:
inputting the received signal, an estimated channel matrix and the interleaved, iterative bit extrinsic LLRs into a serial interference cancellation filter,
wherein step (g) further comprises repeating the above step in addition to steps (b) through (f) for the plurality of iterations.

6. The method of claim 1 further comprising:
determining an estimated covariance by calculating a covariance matrix;
updating SDFE filters and time-reversed SDFE filters with the estimated covariance;
splitting the received signal and sending a first portion of the received signal to the SDFE and sending a second portion of the received signal to the time-reversed SDFE;
filtering the first portion of the received signal with the updated SDFE filters and calculating first bit extrinsic LLRs;
filtering the second portion of the received signal with the updated time-reversed SDFE filters and calculating second bit extrinsic LLRs; and
combining the first bit extrinsic LLRs and the second bit extrinsic LLRs to obtain combined bit extrinsic LLRs.

7. The method of claim 6, wherein the combined bit extrinsic LLRs are determined with the equation
$${L}_{e} ( {c}_{k , j} ) = \frac{1}{1 + {ϱ}_{j}} ( {L}_{e , f} ( {c}_{k , j} ) + {L}_{e , b} ( {c}_{k , j} ) ) ,$$
where L_{e,f}(c_{k,j}) and L_{e,b}(c_{k,j}) are the first bit extrinsic LLRs and the second bit extrinsic LLRs, respectively, and [symbol] ⱼ is a correlation coefficient.

8. The method of claim 7, wherein the correlation coefficient is estimated by time averaging and is determined with the equation
$${\hat{ϱ}}_{j} = \frac{{Σ}_{k = 1}^{{K}_{c}} [ {L}_{e , f} ( {c}_{k , j} ) - {\hat{μ}}_{j , f} ] [ {L}_{e , b} ( {c}_{k , j} ) - {\hat{μ}}_{j , b} ]}{( {K}_{c} - 1 ) {\hat{σ}}_{j , f} {\hat{σ}}_{j , b}} .$$

9. The method of claim 1, wherein the received signal is split between a first leg of the Bi-SDFE and a second leg of the Bi-SDFE, wherein the first leg of the Bi-SDFE includes the SDFE and the second leg of the Bi-SDFE includes a first time-reverse element, the time-reversed SDFE, and a second time-reverse element.

10. The method of claim 1, wherein both the SDFE and the time-reversed SDFE include a feedforward filter and a feedback filter.

11. The method of claim 1, wherein the plurality of iterations comprises a number of iterations determined based on an evaluation of a candidate hard decision at each iteration.

12. The method of claim 1, wherein the plurality of iterations comprises at least five iterations.

13. The method of claim 1, wherein a pilot overhead is set between 12-23%.

14. The method of claim 1, using one of a single-input single output acoustic channel, single-input multiple output acoustic channel, or a multiple-input multiple output acoustic channel.

15. The method of claim 1, wherein the turbo equalizer is one of a linear minimum mean square error turbo equalizer, a soft-decision feedback turbo equalizer, a bi-directional soft-decision feedback turbo equalizer, or a direct adaptation turbo equalizer.

16. A method for estimating, using a Bi-SDFE having a SDFE on a first leg in parallel with a time-reversed SDFE on a second leg, a transmitted symbol encoded on a received signal, the method comprising:
feeding an input signal to each of the first leg and the second leg of the Bi-SDFE;
calculating a covariance matrix to obtain an estimated covariance;
updating a feedforward filter and a feedback filter of the SDFE with the estimated covariance and updating a feedforward filter and a feedback filter of the time-reversed SDFE with the estimated covariance;
filtering, with the SDFE, the input signal communicated to the first leg and determining a first set of bit extrinsic LLRs;
filtering, with the time-reversed SDFE, the input signal communicated to the second leg and determining a second set of bit extrinsic LLRs;
combining the first set of bit extrinsic LLRs and the second set of bit extrinsic LLRs to obtain a combined bit extrinsic LLRs; and
estimating the transmitted symbol encoded on the received signal using the combined bit extrinsic LLRs.

17. An improved single-input single-output (“SISO”) underwater acoustic (“UWA”) modem comprising:
an acoustic receiver comprising at least one acoustic sensor configured to receive SISO UWA transmissions;
a memory; and
a signal processing unit in communication with the acoustic receiver, the signal processing unit configured to jointly perform channel equalization and decoding of the SISO UWA transmissions in an iterative fashion using a bidirectional soft-decision feedback turbo equalizer (“Bi-SDFE”) and a maximum a posteriori probability (“MAP”) decoder.

18. The improved SISO UWA modem of claim 17, wherein the signal processing unit is configured to synchronize and demodulate a received signal to baseband.

19. The improved SISO UWA modem of claim 17, wherein the signal processing unit performs the channel equalization and decoding of each of the SISO UWA transmissions by estimating each received, encoded symbol contained in each of the SISO UWA transmissions using soft decisions for a number of iterations, wherein upon completing the number of iterations a hard decision of the received, encoded symbol is made by the signal processing unit.

20. The improved SISO UWA modem of claim 19, wherein the number of iterations is determined based on determining convergence.
